(19) United States
(12) Patent Application Publication
(10) Pub. No.: US 2016/0246375 A1
(43) Pub. Date: Aug. 25, 2016

(54) Systems And Methods For User Interaction With A Curved Display

(71) Applicant: Immersion Corporation, San Jose, CA (US)

(72) Inventors: William Rihn, San Jose, CA (US); David M. Birnbaum, Oakland, CA (US); Min Lee, San Jose, CA (US)

(21) Appl. No.: 15/052,068

(22) Filed: Feb. 24, 2016

Related U.S. Application Data
(60) Provisional application No. 62/120,737, filed on Feb. 25, 2015.
(60) Provisional application No. 62/120,762, filed on Feb. 25, 2015.

(51) Int. Cl. G06F 3/01; G06F 3/041; G06F 3/0488; G06F 3/0483; G06F 3/0481

(52) U.S. Cl. CPC G06F 3/016; G06F 3/0483; G06F 3/04817; G06F 3/04886; G06F 3/0412

(57) ABSTRACT

Systems and methods for user interaction with a curved display are disclosed. One illustrative method disclosure herein includes: displaying a user interface on a curved display, the curved display comprising a face and an edge; receiving user input on a section of the user interface associated with the edge of the curved display; determining a haptic effect associated with the user interface and the user input; and outputting a haptic signal associated with the haptic effect to a haptic output device.

### CROSS REFERENCE TO RELATED APPLICATION

This Application claims priority to Provisional Application No. 62/120,737, filed on Feb. 25, 2015, and entitled “Method of E-Book Interaction on a Curved Surface,” and Provisional Application No. 62/120,762, filed on Feb. 25, 2015, and entitled “Configuration, Prioritization, and Haptic Display of Notifications on a Mobile Device,” the entirety of both of which is hereby incorporated by reference herein.

### FIELD OF THE INVENTION

The present invention relates to the field of user interface devices. More specifically, the present invention relates to haptic effects and curved displays.

### BACKGROUND

Touch-enabled devices have become increasingly popular. For instance, mobile and other devices may be configured with touch-sensitive displays so that a user can provide input by touching portions of the touch-sensitive display. Some devices are equipped with curved displays. Many devices are further equipped with haptic capability. Accordingly, there is a need for systems and methods for user interaction with a curved display.

### SUMMARY

Embodiments of the present disclosure include devices featuring video display capability and capability to determine haptic signals and output haptic effects. In some embodiments, these haptic effects may comprise surface-based haptic effects that simulate one or more features in a touch area. The touch area may be associated with the display, and the display may be a curved display with both a face and an edge. Features may include, but are not limited to, changes in texture and/or simulation of boundaries, obstacles, or other discontinuities in the touch surface that can be perceived through use of an object, such as a finger, in contact with the surface. In some embodiments haptic effects may comprise surface deformations, vibrations, and other tactile effects. In some embodiments these haptic effects may be used to simulate or enhance features of a graphical user interface displayed in part on an edge of a curved display.

In one embodiment, a method for user interaction with a curved display comprises: displaying a user interface on a curved display, the curved display comprising a face and an edge, the user interface extending onto at least part of both the face and the edge; receiving user input on a section of the user interface associated with the edge of the curved display; determining a haptic effect associated with the user interface and the user input; and outputting a haptic signal associated with the haptic effect to a haptic output device.

In another embodiment, a system for user interaction with a curved display comprises: a curved display configured to display a user interface, the curved display comprising a face and an edge, the user interface extending onto at least part of both the face and the edge; a user input device configured to detect user input on a section of the user interface associated with the edge of the curved display and transmit an interface signal associated with the user input; a haptic output device configured to output a haptic effect; a processor coupled to the curved display, the user interface, and the haptic output device, the processor configured to: receive the interface signal; determine a haptic effect associated with the user interface and the user input; and output a haptic signal associated with the haptic effect to a haptic output device.

In yet another embodiment, a computer readable medium may comprises program code, which when executed by a processor is configured to enable user interaction with a curved display. This program code may comprise program code configured, when executed by a processor, to: display a user interface on a curved display, the curved display comprising a face and an edge, the user interface extending onto at least part of both the face and the edge; receive user input on a section of the user interface associated with the edge of the curved display; determine a haptic effect associated with the user interface and the user input; and output a haptic signal associated with the haptic effect to a haptic output device.

In another embodiment, a method for user interaction with a curved display comprises: displaying a user interface on a curved display; receiving an input signal; determining a modified user interface based on the input signal, wherein the modified user interface comprises displaying one or more icons on an edge of the curved display; determining a haptic effect associated with the modified display; and outputting a haptic signal associated with the haptic effect to a haptic output device.

In another embodiment, a system for user interaction with a curved display comprises: a curved display configured to display a user interface; a haptic output device configured to output a haptic effect; a processor coupled to the curved display and the haptic output device, the processor configured to: receive the input signal; determine a modified user interface based on the input signal, wherein the modified user interface comprises displaying one or more icons on an edge of a curved display; determine a haptic effect associated with the modified display; and output a haptic signal associated with the haptic effect to a haptic output device.

In yet another embodiment, a computer readable medium may comprises program code, which when executed by a processor is configured to enable user interaction with a curved display. This program code may comprise program code configured, when executed by a processor, to: display a user interface on a curved display; receive an input signal; determine a modified user interface based on the input signal, wherein the modified user interface comprises displaying one or more icons on an edge of a curved display; determine a haptic effect associated with the modified display; and output a haptic signal associated with the haptic effect to a haptic output device.

These illustrative embodiments are mentioned not to limit or define the limits of the present subject matter, but to provide examples to aid understanding thereof Illustrative embodiments are discussed in the Detailed Description, and further description is provided there. Advantages offered by various embodiments may be further understood by examining this specification and/or by practicing one or more embodiments of the claimed subject matter.

### BRIEF DESCRIPTION OF THE DRAWINGS

A full and enabling disclosure is set forth more particularly in the remainder of the specification. The specification makes reference to the following appended figures.

FIG. 1A shows an illustrative system for user interaction with a curved display.

FIG. 1B shows an external view of one embodiment of the system shown in FIG. 1A.

FIG. 1C illustrates an external view of another embodiment of the system shown in FIG. 1A.

FIG. 2A illustrates an example embodiment for user interaction with a curved display.

FIG. 2B illustrates another example embodiment for user interaction with a curved display.

FIG. 3A illustrates another example embodiment for user interaction with a curved display.

FIG. 3B illustrates another example embodiment for user interaction with a curved display.

FIG. 4A illustrates another example embodiment for user interaction with a curved display.

FIG. 4B illustrates another example embodiment for user interaction with a curved display.

FIG. 4C illustrates another example embodiment for user interaction with a curved display.

FIG. 5A illustrates another example embodiment for user interaction with a curved display.

FIG. 5B illustrates another example embodiment for user interaction with a curved display.

FIG. 6 is a flow chart of method steps for one example embodiment for user interaction with a curved display.

FIG. 7 is another flow chart of method steps for one example embodiment for user interaction with a curved display.

### DETAILED DESCRIPTION

Reference will now be made in detail to various and alternative illustrative embodiments and to the accompanying drawings. Each example is provided by way of explanation, and not as a limitation. It will be apparent to those skilled in the art that modifications and variations can be made. For instance, features illustrated or described as part of one embodiment may be used in another embodiment to yield a still further embodiment. Thus, it is intended that this disclosure include modifications and variations as come within the scope of the appended claims and their equivalents.

Illustrative Example of a Device for Interaction with a Curved Display

One illustrative embodiment of the present disclosure comprises an electronic device, such as a tablet, e-reader, mobile phone, or computer such as a laptop or desktop computer, or wearable device. The electronic device comprises a display (such as a touch-screen display), a memory, and a processor in communication with each of these elements. In the illustrative embodiment the display comprises a curved display (e.g., the display includes angled surfaces extended onto one or more sides of the electronic device on which images may be displayed). In the illustrative embodiment, the curved display includes at least one face and one edge.

In the illustrative embodiment the curved display is configured to display a graphical user interface. The graphical user interface is configured to extend at least in part onto both the face and edge. The graphical user interface is configured to allow the user to interact with applications executed by the electronic device. These applications may comprises one or more of: games, reading applications, messaging applications, productivity applications, word processing applications, social networking applications, email applications, web browsers, search applications, or other types of applications.

In the illustrative embodiment the curved display comprises a touch screen display and/or other sensors that enable the user to interact with the graphical user interface via one or more gestures. Further, the illustrative electronic device is configured to determine haptic effects in response to events. The illustrative electronic device is configured to output haptic effects via one or more haptic output devices, such as, one or more of: a piezoelectric actuator, an electric motor, an electro-magnetic actuator, a voice coil, a shape memory alloy, an electro-active polymer, a solenoid, an eccentric rotating mass motor, a linear resonant actuator, or an electrostatic output device. An event, as used herein, is any interaction, action, collision, or other event which occurs during operation of the computing device which can potentially comprise an associated haptic effect. In some embodiments, an event may comprise user input or user interaction (e.g., a button press, manipulating a joystick, interacting with a touch-sensitive surface, tilting or orienting the computing device), a system status (e.g., low battery, low memory, or a system notification, such as a notification generated based on the system receiving an incoming call), sending data (e.g., sending an e-mail), receiving data (e.g., receiving a text message), performing a function using the computing device (e.g., placing or receiving a phone call), or a program event (e.g., if the program is a game, a program event may comprise explosions, gunshots, collisions, interactions between game characters, advancing to a new level, or driving over bumpy terrain).

One illustrative user interface that may be displayed on the curved display is a user interface for a reading application. In the illustrative reading application the user may be able to display the text of one or more pages of reading material (e.g., a book, magazine, newspaper, article, web pages, pamphlets, presentation, notebook, text messages, email messages, handwritten documents, encyclopedias, documents in a writing application, documents on a notepad, or some other source of text, graphics, or text and graphics, or a collection of any of these) on the face of the curved display. Further, one edge of the curved display may display an image configured to appear such that it simulates the side of reading material. For example, in the illustrative embodiment, the edge of the curved display may comprise multiple lines mimicking the appearance of the side of reading material (e.g., the stacked pages). Further, in some embodiments, the curved display may comprise an opposite edge, which is configured to display the binding of the reading material. In other embodiments, each side of the device may comprise an edge of the curved display configured to simulate a side of the reading material.

In the illustrative reading application the user may interact with the edge of the curved display in order to change the page of the reading material in the reading application. For example, the user may swipe in one direction, e.g., upward, to move up a page, and swipe in another direction, e.g., downward to move down a page in the reading material.

Further, in the illustrative reading application, as the user interacts with the edge of the curved display the electronic device is configured to determine and output haptic effects. In the illustrative embodiment, these haptic effects are configured to simulate certain features of reading material. For example, in the illustrative embodiment, as the user moves his or her finger along the edge of the curved display the device may determine and output a haptic effect configured to simulate the rough texture of the side of multiple stacked pages. Further, as the user swipes the side of the edge of the display to change page displayed on the face of the display, the device is configured to determine a haptic effect configured to simulate the feeling of moving a page. Further, in the illustrative embodiment other haptic effects may be output on the edge of the curved display to identify the location of certain features, e.g., the location of a new chapter, an illustration, or some other feature within the reading material. In still other embodiments, different haptic effects may be output and/or functions performed based on the pressure of the user input.

Another illustrative user interface that may be displayed on the curved display is a user interface for displaying alerts to the user. In this example, the face of the curved display may display ordinary features of an application. The edge of the display may comprise a space in which icons appear to provide data alerting the user that different events have occurred during operation of the device, e.g. data associated with a text message, a telephone call, an email, a status of an application, or a status of hardware.

In the illustrative device when a new icon appears on the edge of the curved display, the device may output a haptic effect to alert the user. In some embodiments, the strength of this haptic effect may correspond to the importance of the event. For example, a message from a person in the user's favorites may comprise a higher priority than a message from an unknown user, thus, a higher intensity (e.g., higher frequency or amplitude) haptic effect may be output based on receipt of that message.

In the illustrative device, the user may access data associated with the icon by gesturing on the icon, e.g., touching or swiping on the icon. In the illustrative embodiment, when the user gestures on the icon the display of the device may display information associated with the icon, e.g., activate an application associated with the icon to display information. For example, if the icon comprises an alert that a message has been received the device may display a messaging application to allow the user to read the message and respond to it. This messaging application may be displayed either on the face of the curved display, the edge of the curved display, or extended across both the edge and the face of the curved display.

In the illustrative device, once the user addresses the icon, e.g., by swiping the icon, the icon will disappear from the edge of the curved display. In the illustrative embodiment, when the icon disappears the device may be configured to determine a second haptic effect. This haptic effect may be associated with the user's interaction, e.g., the pressure of the interaction, the speed of the interaction, the location of the interaction, or the type of object used in the interaction (e.g., finger, thumb, stylus, etc.). In the illustrative device, this haptic effect may be configured to provide further information associated with the icon, e.g., that a task has begun, been completed, or that further attention may be required at another time. In still other embodiments, different haptic effects may be output and/or functions performed based on the pressure of the user input.

Illustrative Systems for User Interaction with a Curved Display

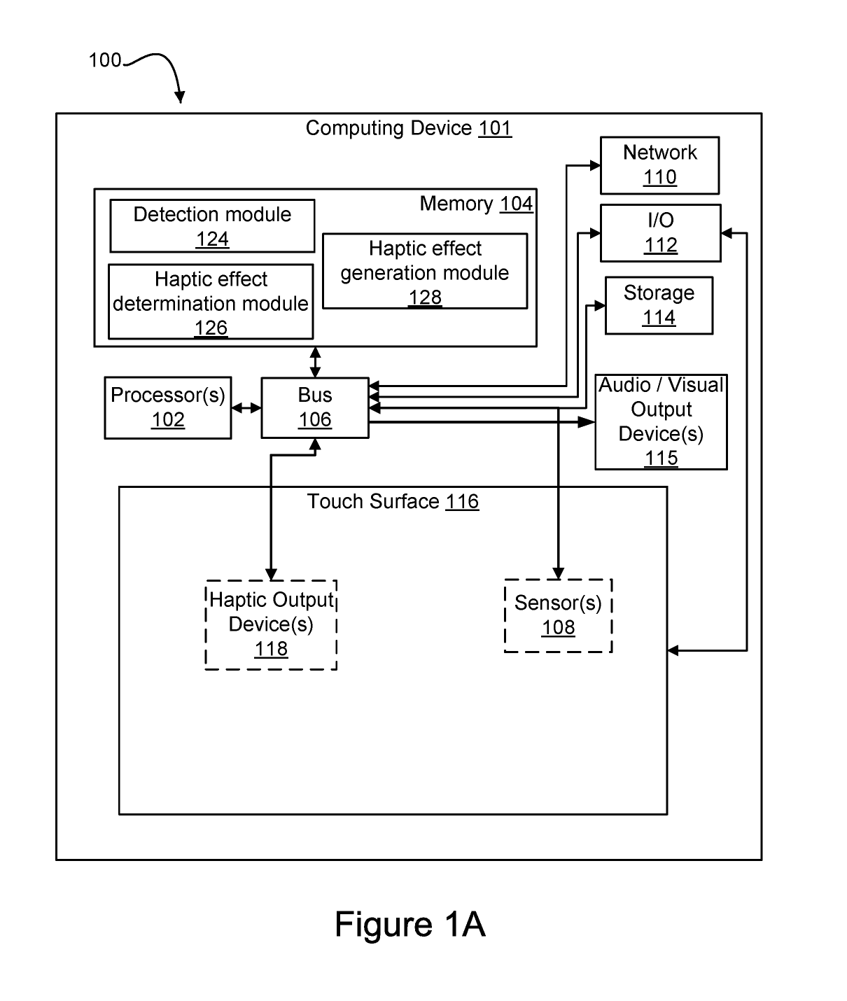

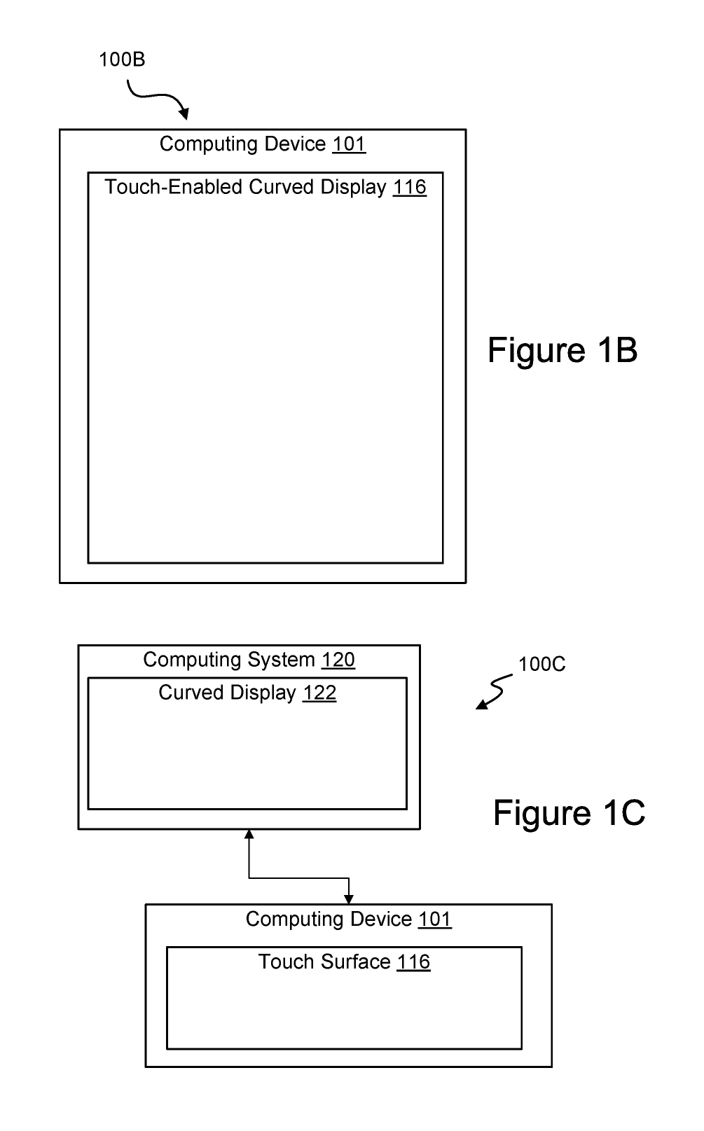

FIG. 1A shows an illustrative system 100 for user interaction with a curved display. Particularly, in this example, system 100 comprises a computing device 101 having a processor 102 interfaced with other hardware via bus 106. A memory 104, which can comprise any suitable tangible (and non-transitory) computer-readable medium such as RAM, ROM, EEPROM, or the like, embodies program components that configure operation of the computing device. In this example, computing device 101 further includes one or more network interface devices 110, input/output (I/O) interface components 112, and additional storage 114.

Network device 110 can represent one or more of any components that facilitate a network connection. Examples include, but are not limited to, wired interfaces such as Ethernet, USB, IEEE 1394, and/or wireless interfaces such as IEEE 802.11, Bluetooth, or radio interfaces for accessing cellular telephone networks (e.g., transceiver/antenna for accessing a CDMA, GSM, UMTS, or other mobile communications network).

I/O components 112 may be used to facilitate connection to devices such as one or more displays, curved displays (e.g., the display includes angled surfaces extended onto one or more sides of computing device 101 on which images may be displayed), keyboards, mice, speakers, microphones, cameras (e.g., a front and/or a rear facing camera on a mobile device) and/or other hardware used to input data or output data. Storage 114 represents nonvolatile storage such as magnetic, optical, or other storage media included in device 101.

Audio/visual output device(s) 115 comprise one or more devices configured to receive signals from processor(s) 102 and provide audio or visual output to the user. For example, in some embodiments, audio/visual output device(s) 115 may comprise a display such as a touch-screen display, LCD display, plasma display, CRT display, projection display, or some other display known in the art. Further, audio/visual output devices may comprise one or more speakers configured to output audio to a user.

System 100 further includes a touch surface 116, which, in this example, is integrated into device 101. Touch surface 116 represents any surface that is configured to sense touch input of a user. One or more sensors 108 may be configured to detect a touch in a touch area when an object contacts a touch surface and provide appropriate data for use by processor 102. Any suitable number, type, or arrangement of sensors can be used. For example, resistive and/or capacitive sensors may be embedded in touch surface 116 and used to determine the location of a touch and other information, such as pressure. As another example, optical sensors with a view of the touch surface may be used to determine the touch position. In some embodiments, sensor 108 and touch surface 116 may comprise a touch-screen or a touch-pad. For example, in some embodiments, touch surface 116 and sensor 108 may comprise a touch-screen mounted overtop of a display configured to receive a display signal and output an image to the user. In other embodiments, the sensor 108 may comprise an LED detector. For example, in one embodiment, touch surface 116 may comprise an LED finger detector mounted on the side of a display. In some embodiments, the processor is in communication with a single sensor 108, in other embodiments, the processor is in communication with a plurality of sensors 108, for example, a first touch screen and a second touch screen. In some embodiments one or more sensor(s) 108 further comprise one or more sensors configured to detect movement of the mobile device (e.g., accelerometers, gyroscopes, cameras, GPS, or other sensors). These sensors may be configured to detect user interaction that moves the device in the X, Y, or Z plane. The sensor 108 is configured to detect user interaction, and based on the user interaction, transmit signals to processor 102. In some embodiments, sensor 108 may be configured to detect multiple aspects of the user interaction. For example, sensor 108 may detect the speed and pressure of a user interaction, and incorporate this information into the interface signal. Further, in some embodiments, the user interaction comprises a multi-dimensional user interaction away from the device. For example, in some embodiments a camera associated with the device may be configured to detect user movements, e.g., hand, finger, body, head, eye, or feet motions or interactions with another person or object.

In some embodiments, the input may comprise a gesture. A gesture is any movement of the body that conveys meaning or user intent. It will be recognized that simple gestures may be combined to form more complex gestures. For example, bringing a finger into contact with a touch sensitive surface may be referred to as a “finger on” gesture, while removing a finger from a touch sensitive surface may be referred to as a separate “finger off” gesture. If the time between the “finger on” and “finger off” gestures is relatively short, the combined gesture may be referred to as “tapping;” if the time between the “finger on” and “finger off” gestures is relatively long, the combined gesture may be referred to as “long tapping;” if the distance between the two dimensional (x, y) positions of the “finger on” and “finger off” gestures is relatively large, the combined gesture may be referred to as “swiping;” if the distance between the two dimensional (x, y) positions of the “finger on” and “finger off” gestures is relatively small, the combined gesture may be referred to as “smearing,” “smudging,” or “flicking.” Any number of two dimensional or three dimensional simple or complex gestures may be combined in any manner to form any number of other gestures, including, but not limited to, multiple finger contacts, palm or first contact, or proximity to the device. A gesture can also be any form of hand movement recognized by a device having an accelerometer, gyroscope, or other motion sensor, and converted to electronic signals. Such electronic signals can activate a dynamic effect, such as shaking virtual dice, where the sensor captures the user intent that generates a dynamic effect.

In this example, a haptic output device 118 in communication with processor 102 is coupled to touch surface 116. In some embodiments, haptic output device 118 is configured to output a haptic effect simulating a texture on the touch surface in response to a haptic signal. Additionally or alternatively, haptic output device 118 may provide vibrotactile haptic effects that move the touch surface in a controlled manner. Some haptic effects may utilize an actuator coupled to a housing of the device, and some haptic effects may use multiple actuators in sequence and/or in concert. For example, in some embodiments, a surface texture may be simulated by vibrating the surface at different frequencies. In such an embodiment haptic output device 118 may comprise one or more of, for example, a piezoelectric actuator, an electric motor, an electro-magnetic actuator, a voice coil, a shape memory alloy, an electro-active polymer, a solenoid, an eccentric rotating mass motor (ERM), or a linear resonant actuator (LRA). In some embodiments, haptic output device 118 may comprise a plurality of actuators, for example an ERM and an LRA. In some embodiments, haptic output device 118 may be configured to output haptic effects to the edge of a curved display. Alternatively, in some embodiments, haptic output device 118 may be configured to output haptic effects to the face of a curved display or to both the face and the edge of a curved display.

In some embodiments, one or more haptic output devices may be configured to output forces in the X, Y, or Z plane with respect to the device. In some embodiments, these effects may be configured to simulate the feeling of an object within the display moving. For example, in one embodiment, a multidimensional haptic effect may be configured to simulate an object (such as an icon or the pages in reading material) moving in the X-plane (left or right), the Y-plane (up or down), the Z-plane (into or out of the display), or vectors in these planes. These multi-dimensional haptic effects may simulate features.

Although a single haptic output device 118 is shown here, embodiments may use multiple haptic output devices of the same or different type to output haptic effects, e.g., to simulate surface textures on the touch surface. For example, in one embodiment, a piezoelectric actuator may be used to displace some or all of touch surface 116 vertically and/or horizontally at ultrasonic frequencies, such as by using an actuator moving at frequencies greater than 20-25 kHz in some embodiments. In some embodiments, multiple actuators such as eccentric rotating mass motors and linear resonant actuators can be used alone or in concert to provide different textures and other haptic effects.

In still other embodiments, haptic output device 118 may use electrostatic attraction, for example by use of an electrostatic surface actuator, to simulate a texture on the surface of touch surface 116. Similarly, in some embodiments haptic output device 118 may use electrostatic attraction to vary the friction the user feels on the surface of touch surface 116. For example, in one embodiment, haptic output device 118 may comprise an electrostatic display or any other device that applies voltages and currents instead of mechanical motion to generate a haptic effect. In such an embodiment, an electrostatic actuator may comprise a conducting layer and an insulating layer. In such an embodiment, the conducting layer may be any semiconductor or other conductive material, such as copper, aluminum, gold, or silver. And the insulating layer may be glass, plastic, polymer, or any other insulating material. In some embodiments, touch surface 116 may comprise a curved surface.

The processor 102 may operate the electrostatic actuator by applying an electric signal to the conducting layer. The electric signal may be an AC signal that, in some embodiments, capacitively couples the conducting layer with an object near or touching touch surface 116. In some embodiments, the AC signal may be generated by a high-voltage amplifier. In other embodiments the capacitive coupling may simulate a friction coefficient or texture on the surface of the touch surface 116. For example, in one embodiment, the surface of touch surface 116 may be smooth, but the capacitive coupling may produce an attractive force between an object near the surface of touch surface 116. In some embodiments, varying the levels of attraction between the object and the conducting layer can vary the simulated texture on an object moving across the surface of touch surface 116 or vary the coefficient of friction felt as the object moves across the surface of touch surface 116. Furthermore, in some embodiments, an electrostatic actuator may be used in conjunction with traditional actuators to vary the simulated texture on the surface of touch surface 116. For example, the actuators may vibrate to simulate a change in the texture of the surface of touch surface 116, while at the same time; an electrostatic actuator may simulate a different texture, or other effects, on the surface of touch surface 116 or on another part of the computing device 101 (e.g., its housing or another input device).

One of ordinary skill in the art will recognize that multiple techniques may be used to output haptic effects such as varying the coefficient of friction or simulating a texture on a surface. For example, in some embodiments, a texture may be simulated or output using a flexible surface layer configured to vary its texture based upon contact from a surface reconfigurable haptic substrate (including, but not limited to, e.g., fibers, nanotubes, electroactive polymers, piezoelectric elements, or shape memory allows) or a magnetorheological fluid. In another embodiment, surface texture may be varied by raising or lowering one or more surface features, for example, with a deforming mechanism, air or fluid pockets, local deformation of materials, resonant mechanical elements, piezoelectric materials, micro-electromechanical systems (“MEMS”) elements, thermal fluid pockets, MEMS pumps, variable porosity membranes, or laminar flow modulation.

In some embodiments, an electrostatic actuator may be used to generate a haptic effect by stimulating parts of the body near or in contact with the touch surface 116. For example, in some embodiments, an electrostatic actuator may stimulate the nerve endings in the skin of a user's finger or components in a stylus that can respond to the electrostatic actuator. The nerve endings in the skin, for example, may be stimulated and sense the electrostatic actuator (e.g., the capacitive coupling) as a vibration or some more specific sensation. For example, in one embodiment, a conducting layer of an electrostatic actuator may receive an AC voltage signal that couples with conductive parts of a user's finger. As the user touches the touch surface 116 and moves his or her finger on the touch surface, the user may sense a texture of prickliness, graininess, bumpiness, roughness, stickiness, or some other texture.

Turning to memory 104, exemplary program components 124, 126, and 128 are depicted to illustrate how a device can be configured in some embodiments to provide user interaction with a curved display. In this example, a detection module 124 configures processor 102 to monitor touch surface 116 via sensor 108 to determine a position of a touch. For example, module 124 may sample sensor 108 in order to track the presence or absence of a touch and, if a touch is present, to track one or more of the location, path, velocity, acceleration, pressure, and/or other characteristics of the touch over time.

Haptic effect determination module 126 represents a program component that analyzes data regarding touch characteristics to select a haptic effect to generate. For example, in one embodiment, module 126 comprises code that determines, based on the location of the touch, a haptic effect to generate. For example, haptic effect determination module 126 may comprise one or more preloaded haptic effects, which may be selected by the user. These haptic effects may comprise any type of haptic effect that haptic output device(s) 118 are capable of generating. Further, in some embodiments, module 126 may comprise program code configured to manipulate characteristics of a haptic effect, e.g., the effect's intensity, frequency, duration, duty cycle, or any other characteristic associated with a haptic effect. In some embodiments, module 126 may comprise program code to allow the user to manipulate these characteristics, e.g., via a graphical user interface.

Further, in some embodiments, module 126 may comprise program code configured to determine haptic effects based on user interactions. For example, module 126 may be configured to monitor user input on touch surface 116 or other sensors, such as inertial sensors, configured to detect motion of the mobile device. Module 126 may detect this input and generate a haptic effect based on the input. For example, in some embodiments module 126 may be configured to determine a haptic effect configured to simulate the user interaction.

Haptic effect generation module 128 represents programming that causes processor 102 to generate and transmit a haptic signal to haptic output device 118, which causes haptic output device 118 to generate the selected haptic effect. For example, generation module 128 may access stored waveforms or commands to send to haptic output device 118. As another example, haptic effect generation module 128 may receive a desired type of texture and utilize signal processing algorithms to generate an appropriate signal to send to haptic output device 118. As a further example, a desired texture may be indicated along with target coordinates for the haptic effect and an appropriate waveform sent to one or more actuators to generate appropriate displacement of the surface (and/or other device components) to provide the haptic effect. Some embodiments may utilize multiple haptic output devices in concert to output a haptic effect. For instance, a variation in texture may be used to simulate crossing a boundary between a button on an interface while a vibrotactile effect simulates that a button was pressed.

A touch surface may overlay (or otherwise correspond to) a display, depending on the particular configuration of a computing system. In FIG. 1B, an external view of a computing system 100B is shown. Computing device 101 includes a touch enabled curved display 116 that combines a touch surface and a display of the device. The touch surface may correspond to the display exterior or one or more layers of material above the actual display components.

FIG. 1C illustrates another example of a touch enabled computing system 100C in which the touch surface does not overlay a curved display. In this example, a computing device 101 features a touch surface 116 which may be mapped to a graphical user interface provided in a curved display 122 that is included in computing system 120 interfaced to device 101. For example, computing device 101 may comprise a mouse, trackpad, or other device, while computing system 120 may comprise a desktop or laptop computer, set-top box (e.g., DVD player, DVR, cable television box), or another computing system. As another example, touch surface 116 and curved display 122 may be disposed in the same device, such as a touch enabled trackpad in a laptop computer featuring curved display 122. Whether integrated with a display or otherwise, the depiction of planar touch surfaces in the examples herein is not meant to be limiting. Other embodiments include curved or irregular touch enabled surfaces that are further configured to provide surface-based haptic effects.

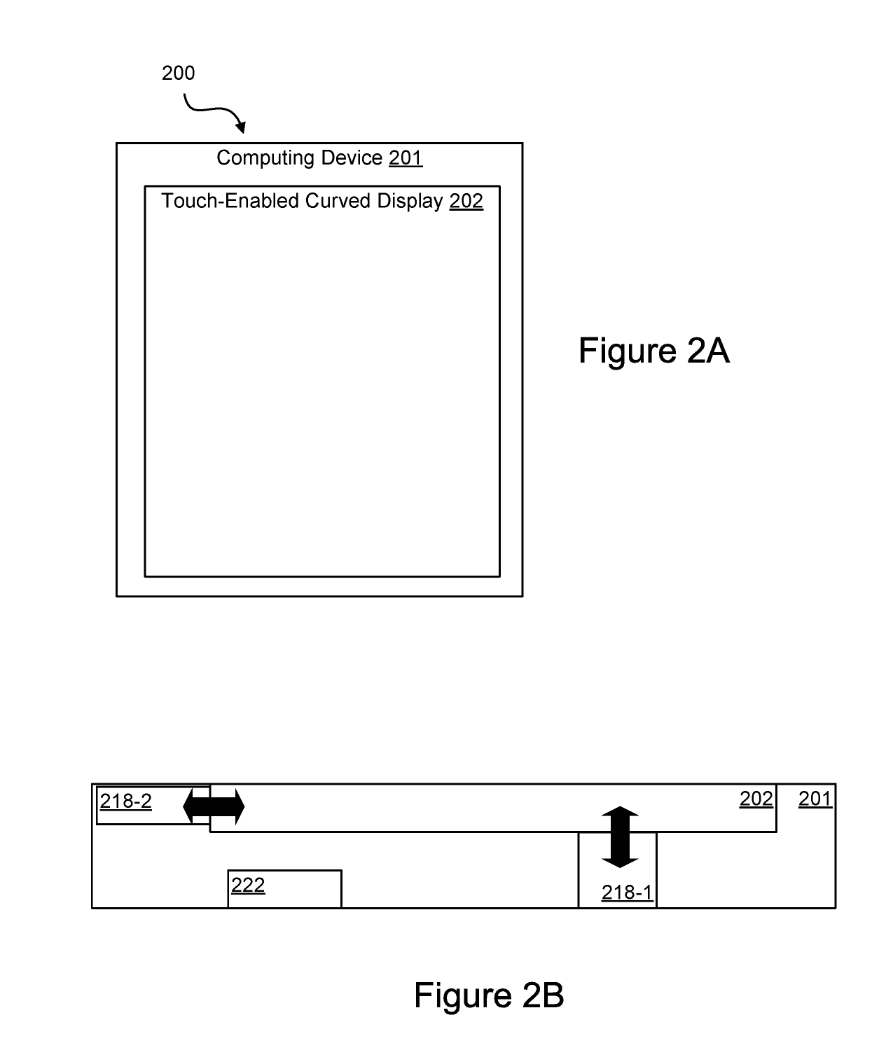

FIGS. 2A-2B illustrate an example embodiment of a device for user interaction with a curved display. FIG. 2A is a diagram illustrating an external view of a system 200 comprising a computing device 201 that features a touch enabled curved display 202. FIG. 2B shows a cross-sectional view of device 201. Device 201 may be configured similarly to device 101 of FIG. 1A, though components such as the processor, memory, sensors, and the like are not shown in this view for purposes of clarity.

As can be seen in FIG. 2B, device 201 features a plurality of haptic output devices 218 and an additional haptic output device 222. Haptic output device 218-1 may comprise an actuator configured to impart vertical force to curved display 202, while 218-2 may move curved display 202 laterally. In this example, the haptic output devices 218, 222 are coupled directly to the display, but it should be understood that the haptic output devices 218, 222 could be coupled to another touch surface, such as a layer of material on top of curved display 202. Furthermore, it should be understood that one or more of haptic output devices 218 or 222 may comprise an electrostatic actuator, as discussed above. Furthermore, haptic output device 222 may be coupled to a housing containing the components of device 201. In the examples of FIGS. 2A-2B, the area of curved display 202 corresponds to the touch area, though the principles could be applied to a touch surface completely separate from the display.

In one embodiment, haptic output devices 218 each comprise a piezoelectric actuator, while additional haptic output device 222 comprises an eccentric rotating mass motor, a linear resonant actuator, or another piezoelectric actuator. Haptic output device 222 can be configured to provide a vibrotactile haptic effect in response to a haptic signal from the processor. The vibrotactile haptic effect can be utilized in conjunction with surface-based haptic effects and/or for other purposes. For example, each actuator may be used in conjunction to simulate a texture on the surface of curved display 202.

In some embodiments, either or both haptic output devices 218-1 and 218-2 can comprise an actuator other than a piezoelectric actuator. Any of the actuators can comprise a piezoelectric actuator, an electromagnetic actuator, an electroactive polymer, a shape memory alloy, a flexible composite piezo actuator (e.g., an actuator comprising a flexible material), electrostatic, and/or magnetostrictive actuators, for example. Additionally, haptic output device 222 is shown, although multiple other haptic output devices can be coupled to the housing of device 201 and/or haptic output devices 222 may be coupled elsewhere. Device 201 may feature multiple haptic output devices 218-1/218-2 coupled to the touch surface at different locations, as well.

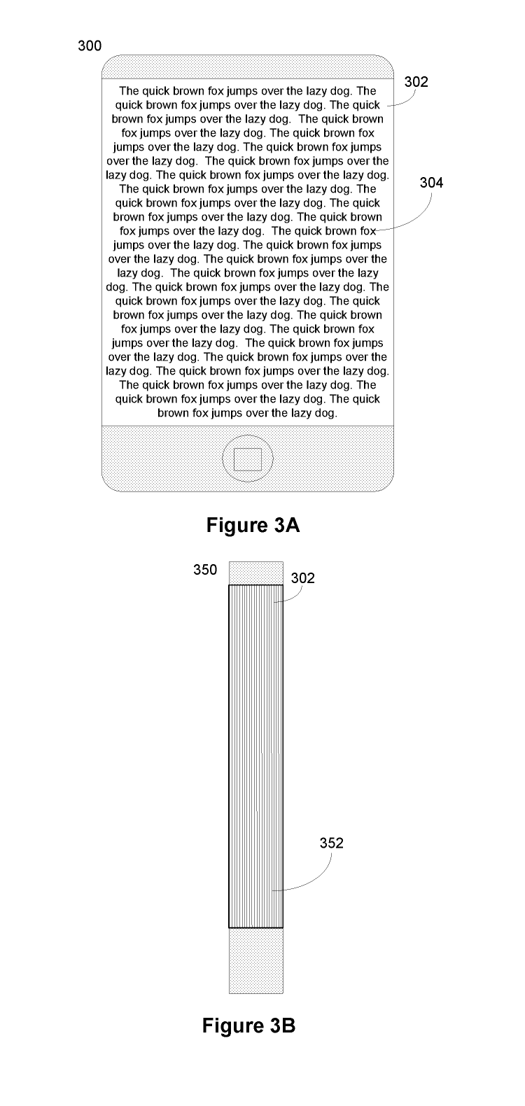

Turning now to FIG. 3A, FIG. 3A illustrates another example embodiment for user interaction with a curved display. The embodiment shown in FIG. 3A comprises a computing device 300. As shown in FIG. 3A, computing device 300 comprises a curved touch screen display 302. FIG. 3A shows a view of the face of curved touch screen display 302. Further, as shown in FIG. 3A, computing device 300 is executing a reading application and displays many lines of text 304, e.g., the text from reading material such as a book, magazine, newspaper, article, web pages, pamphlets, presentation, notebook, text messages, email messages, handwritten documents, encyclopedias, documents in a writing application, documents on a notepad, or some other source of text, graphics, or text and graphics, or a collection of any of these.

Turning now to FIG. 3B, FIG. 3B illustrates a view 350 of the side of the device shown in FIG. 3A. As shown in FIG. 3B, computing device 350 comprises an edge of the curved touch screen display 302. The edge of the curved touch screen display extends onto at least one side of the device. As shown in FIG. 3B, the curved display extends on the left or right side of the device. However, in other embodiments, the curved display may extend onto the top, bottom, left, right, corners, and back of the display. Further, in some embodiments, the sides of the device may each comprise an additional display, e.g., in some embodiments, each side of the computing device 300 may comprise its own display.

As shown in FIG. 3B, the edge of curved display 302 comprises a graphical user interface. The edge of the graphical user interface comprises an image configured to simulate the side of reading material, e.g., multiple pages 352 pressed tightly together. In the embodiment shown in FIG. 3B the user may scroll through the pages 352 by gesturing on the edge of the device 350. As the user scrolls different pages may be displayed on the face of display 302, thus enabling the reading application to more realistically simulate perusing reading material. Depending on characteristics of the gesture (e.g., speed, pressure, acceleration, contact area, or other characteristic) the application executing on device 300 may scroll through a greater or lesser number of pages or jump to a specific location in the reading material. Further, the device may determine one or more haptic effects configured to simulate the feel and movement of the pages 352 as the user scrolls.

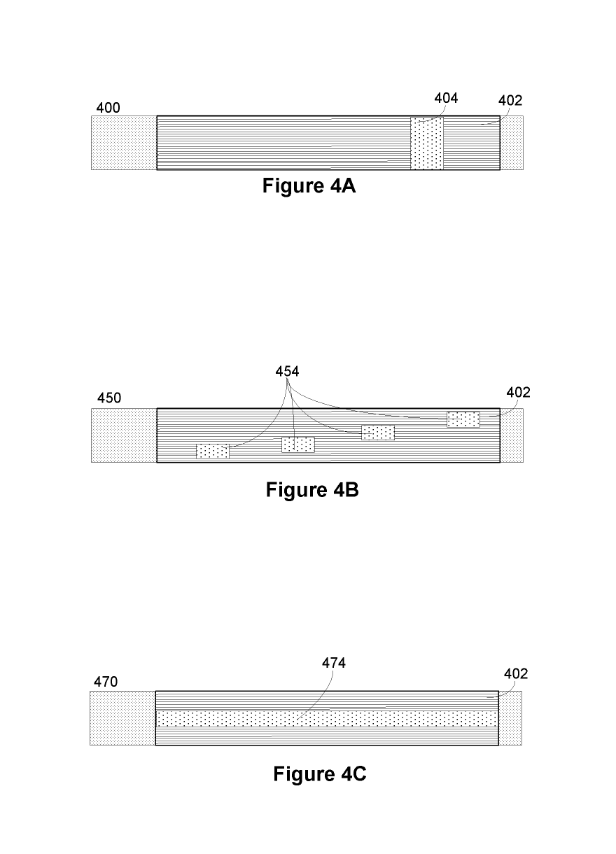

Turning now to FIG. 4A, FIG. 4A illustrates a view of the side of the device shown in FIG. 3A. FIG. 4A shows a visual representation of a location of user interaction 404. When the user interacts with location 404 the computing device 400 is configured to output a haptic effect to simulate characteristics of the user interface of the device 400. As shown in FIG. 4A, the haptic effect may comprise a haptic effect configured to simulate the feeling of each individual page as the user moves across the edge of the display. The haptic effect may be output by one or more haptic output devices (discussed above) and comprise a frequency and amplitude that is variable based on the speed, location, and/or pressure of the user's gesture. Modulation of the frequency and amplitude of the haptic effect output by one or more haptic output devices may simulate the feeling of pages as the user moves a finger across the edge of display 402.

Turning now to FIG. 4B, FIG. 4B illustrates a view of the side of the device shown in FIG. 3A. FIG. 4B shows a visual representation of locations of user interaction 454. When the user interacts with location 454 the computing device 400 is configured to output a haptic effect to simulate characteristics of the user interface of the device 400. As shown in FIG. 4B, the haptic effect may comprise a haptic effect configured to simulate the feeling of specific features at locations within the document the user is reading, e.g., haptic effects configured to simulate new chapters, the location of illustrations, the location of new articles, the location of search terms, the location of a bookmark, the location of a picture, the location of an index, the location of a glossary, the location of a bibliography, and/or the location of some other feature associated with the document. After feeling this haptic effect the user may be able to quickly scroll to the location of the feature by gesturing on the edge of the curved touch screen display 402. This gesture may be, e.g., a swipe or pressure applied to the edge 402. In some embodiments, the computing device 450 may vary one or more characteristics of the haptic effect (e.g., frequency, amplitude, duty cycle, etc.) based on the speed or amount of pressure applied by the user. As the user scrolls to a new page the face of the curved display 402 may display the page to which the user scrolled.

Turning now to FIG. 4C, FIG. 4C illustrates a view of the side of the device shown in FIG. 3A. FIG. 4C shows a visual representation of locations of user interaction 474. When the user interacts with location 474 the computing device 400 is configured to output a haptic effect to simulate characteristics of the user interface of the device 400. As shown in FIG. 4B, the haptic effect may comprise a haptic effect configured to simulate the feeling of one or more pages turning. For example, modulation of the frequency and amplitude of the haptic effect output by one or more haptic output devices may simulate the feeling of pages turning as the user moves a finger across the edge of display 402.

The examples given in FIGS. 3A-4C above are illustrative. In other embodiments the user interface and haptic effects may be configured for use in any other application for which a stacking or pagination metaphor is appropriate including a text editor. For example, in a gaming application, such as a card-game (e.g., the face of the display shows the face of one or more cards and the edge of the display shows the sides of the cards), picture application or picture editor (e.g., the face of the display shows the front of one or more pictures and the edge of the display shows the sides of the pictures), video application or video editor (e.g., the face of the display shows the video and the edge of the display shows a stack of images moving toward the display), timeline application (e.g., the face of the display shows the current time and the edge of the display shows the sides of the entries in the timeline), contact list application (e.g., the face of the display shows the current contact and the edge of the display shows the sides of the stacked contacts), or presentation application (e.g., the face of the display shows the face of one or more slides and the edge of the display shows the sides of the stacked slides), along with corresponding haptic effects.

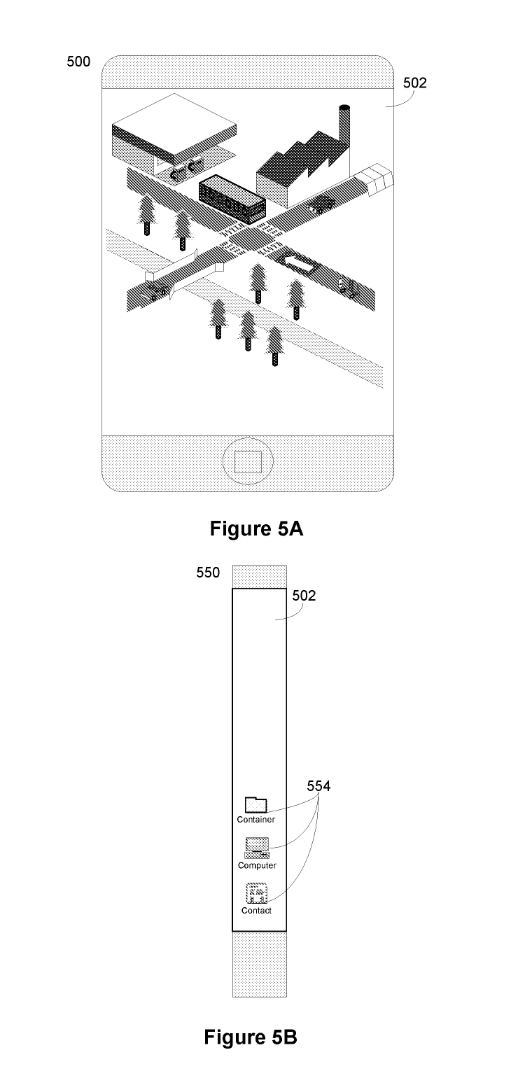

Turning now to FIG. 5A, FIG. 5A illustrates another example embodiment for user interaction with a curved display. The embodiment shown in FIG. 5A comprises a computing device 500. As shown in FIG. 5A, computing device 500 comprises a curved touch screen display 502. FIG. 5A shows a view of the face of curved touch screen display 502. As shown in 5A, the face of the curved touch screen display 502 displays an application currently being executed by computing device 500.

Turning now to FIG. 5B, FIG. 5B illustrates a view of the side of the device shown in FIG. 5A. As shown in FIG. 5B, computing device 550 comprises an edge of the curved touch screen display 502. The edge of the curved touch screen display extends onto at least one side of the device. As shown in FIG. 3B, the curved display extends onto the left or right side of the device. However, in other embodiments, the curved display may extend onto the top, bottom, left, right, corners, and back of the display. Further, in some embodiments, the sides of the device may each comprise an additional display, e.g., in some embodiments, each side of the computing device 500 may comprise its own display.

As shown in FIG. 5B, the edge of curved display 502 comprises a graphical user interface. The edge of the graphical user interface comprises an image configured to show multiple icons 554. These icons represent alerts associated with events on the computing device 500. These events may comprise, e.g., receipt of a text message, a telephone call, an email, or an alert associated with a status of an application or a status of hardware. In some embodiments the icon may appear in its present location. Alternatively, in some embodiments the icon may have an animated appearance, e.g., it may appear in a simulate cloud of smoke or from one location on the display and move to another location, e.g., the location in which is shown in FIG. 5B.

In some embodiments, the user may gesture on icons 554 to receive additional information associated with the icon. For example, the user may interact with the icon to obtain more information about the alert. In one embodiment, the icon comprises an alert about battery life. Thus, when the user gestures on the icon the device may open an application that shows the user the remaining battery life, visibly, audibly, and/or haptically (e.g., an effect to simulate the fullness of a tank or box to indicate the charge remaining). In another embodiment, the icon may comprise an icon associated with a received message, and a gesture on the icon may open the messaging application so the user can read the message and respond to it. In some embodiments, the device may determine different functions based on characteristics associated with the gesture, e.g., a different function for varying pressure, speed, or direction of user interaction.

In some embodiments, when the icon appears the computing device 550 may determine and output a haptic effect. This haptic effect may be configured to alert the user that there is an alert and the type of the alert (e.g., different frequency or amplitude vibrations for different types of alerts). Further, in some embodiments, the icons 554 may have virtual physical characteristics. For example, the icons 554 may comprise a virtual mass and respond to movement of the device as though they have momentum, e.g., by moving and/or colliding. Similarly, the icons 554 may respond to gravity, e.g., by falling onto the display at a rate that varies depending on the angle at which the display is sitting. Thus, the icons may move based on certain gestures, e.g., tilting or moving the computing device 550. As the icons move the computing device 550 may determine and output haptic effects configured to simulate the movements and collisions of the icons.

In some embodiments, after the user gestures on an icon the icon may disappear, e.g., because the user has resolved an issue associated with the alert (e.g., responded to the message). When the icon disappears, the computing device 550 may determine and output another haptic effect configured to alert the user that the alert is resolved.

Illustrative Methods for User Interaction with a Curved Display

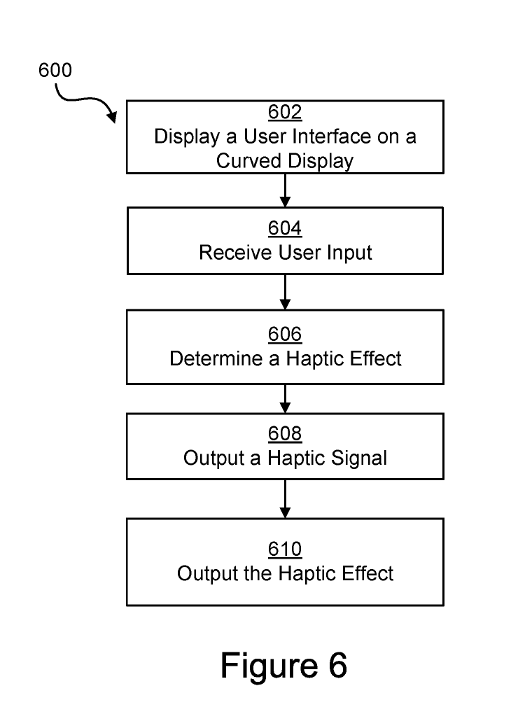

FIG. 6 is a flow chart of steps for performing a method for user interaction with a curved display according to one embodiment. In some embodiments, the steps in FIG. 6 may be implemented in program code that is executed by a processor, for example, the processor in a general purpose computer, a mobile device, or a server. In some embodiments, these steps may be implemented by a group of processors. In some embodiments one or more steps shown in FIG. 6 may be omitted or performed in a different order. Similarly, in some embodiments, additional steps not shown in FIG. 6 may also be performed. The steps below are described with reference to components described above with regard to computing device 100 shown in FIG. 1.

The method 600 begins at step 602 when the processor 102 displays a user interface on a curved display. As discussed above, the user interface is displayed, at least in part, on both the edge and face of the curved display. In some embodiments, the user interface may comprise a user interface for a reading application, e.g., the face of the curved display may display the page that the user is reading and one or more edges of the curved display may show a side view of reading material, e.g., pages and/or the binding. In other embodiments the user interface may comprise other types of interfaces, for example a game interface (e.g., a card game), picture application, video application, timeline application, contact list application, or presentation application.

Next the processor 102 receives user input 604. In some embodiments, the user input may be with a touch surface 116, which may comprise a touch-screen display. Further in some embodiments, the user input may be detected by another user input device. The user input may comprise user input on an edge of a curved touch screen display.

At step 606 the processor 102 determines a haptic effect. In some embodiments the haptic effect may be configured to simulate features associated with the user interface discussed above. For example, if the user interface comprises a reading application the haptic effect may be configured to simulate the feeling of pages or the movement of pages as the user turns one or more pages. Further, in some embodiments the haptic effect may be configured to simulate features within a page, e.g., the location of an illustration, a new chapter, a bookmark, or some other feature associated with the application.

In other embodiments, the haptic effect may be associated with other features of the interface, e.g., if the interface comprises an email interface, the haptic effect may simulate the movement of letters, or the shuffling of a stack of letters. Alternatively, if the user interface comprises an interface for a picture application the haptic effect may be configured to simulate the feel of the side of a stack of images.

In other embodiments, the processor may determine a haptic effect based on user selection. For example, the user may select an available haptic effect. For example, a data store of computing device 101 may comprise data associated with multiple haptic effects, which the user may select. Further, the user may adjust characteristics associated with the haptic effect. For example, the user may modify the duration, frequency, intensity, or some other characteristic associated with the haptic effect. In some embodiments, the processor 102 may automatically select the haptic effect. For example, in some embodiments, the processor 102 may select a haptic effect associated with events occurring within a video displayed on the face of the curved display.

Next the processor 608 outputs a haptic signal. To output the haptic effect the processor 102 may transmit a haptic signal associated with the haptic effect to haptic output device 118, which outputs the haptic effect.

At step 610 the haptic output device 118 outputs the haptic effect. The haptic effect may comprise a texture (e.g., sandy, bumpy, or smooth), a vibration, a change in a perceived coefficient of friction, a change in temperature, a stroking sensation, an electro-tactile effect, or a deformation (e.g., a deformation of a surface associated with the computing device 101).

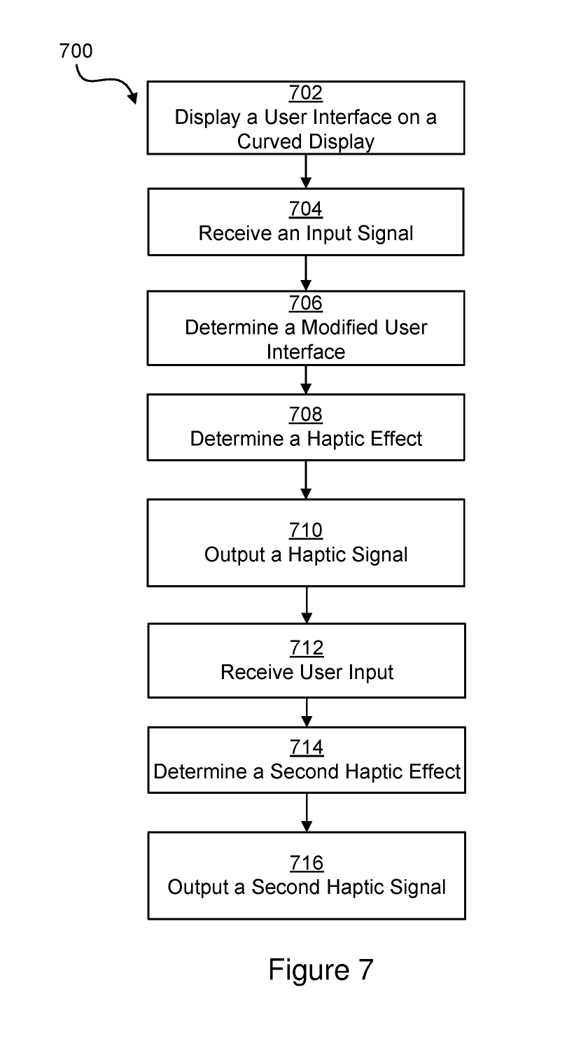

FIG. 7 is a flow chart of steps for performing a method for user interaction with a curved display according to one embodiment. In some embodiments, the steps in FIG. 7 may be implemented in program code that is executed by a processor, for example, the processor in a general purpose computer, a mobile device, or a server. In some embodiments, these steps may be implemented by a group of processors. In some embodiments one or more steps shown in FIG. 7 may be omitted or performed in a different order. Similarly, in some embodiments, additional steps not shown in FIG. 7 may also be performed. The steps below are described with reference to components described above with regard to computing device 100 shown in FIG. 1.

The method 700 begins at step 702 when the processor 102 displays a user interface on a curved display. As discussed above, the user interface is displayed, at least in part, on both the edge and face of the curved display. In some embodiments, the user interface may display an interface for an application on the face of the display. In such an embodiment, the user interface may display an alert window on the edge of the curved display.

Next the processor 102 receives an input signal 704. The input signal may comprise a signal associated with the status of an executing application, receipt of a message, or a status of hardware. For example, the input signal may comprise a message associated with receipt of a text message, a telephone call, an email, or the status of battery life, network strength, volume settings, display settings, connectivity to other device, an executing application, a background application, or some other type of alert related to an event.

At step 706 the processor 102 determines a modified user interface. In some embodiments the modified user interface comprises display of an alert icon on the edge of the curved display. In some embodiments the icon may appear in its present location. Alternatively, in some embodiments the icon may have an animated appearance, e.g., it may appear in a simulate cloud of smoke or from one location on the display and move to another location. This icon may be configured to alert the user of information associated with the input signal discussed above at step 704.

Next the processor 102 determines a haptic effect 708. In some embodiments the haptic effect is configured to alert the user of the information discussed at step 704. The haptic effect may be a simple alert to let the user know that an icon has appeared. In other embodiments the processor 102 may vary characteristics of the haptic effect (e.g., amplitude, frequency, or duty cycle) to alert the user of the importance of the information. For example, a significant weather advisory may be associated with a more powerful haptic alert than an email from an unknown sender.

In other embodiments, the processor may determine a haptic effect based on user selection. For example, the user may select an available haptic effect. For example, a data store of computing device 101 may comprise data associated with multiple haptic effects, which the user may select. Further, the user may adjust characteristics associated with the haptic effect. For example, the user may modify the duration, frequency, intensity, or some other characteristic associated with the haptic effect. In some embodiments, the processor 102 may automatically select the haptic effect. For example, in some embodiments, the processor 102 may select a haptic effect associated with events occurring within a video displayed on the face of the curved display.

At step 710 the processor 102 outputs a haptic signal. The haptic signal may comprise a first haptic signal associated with the first haptic effect. The processor 102 may transmit the first haptic signal to one or more haptic output device(s) 118, which output the haptic effect.

Next the processor 102 receives user input 712. In some embodiments, the user input may be with a touch surface 116, which may comprise a touch-screen display. Further in some embodiments, the user input may be detected by another user input device. The user input may comprise user input on an edge of a curved touch screen display, e.g., an edge displaying the graphical user interface discussed above at step 702. In some embodiments, on receipt of the user input the icon is removed from the user interface.

Further, in some embodiments, upon receipt of the user input, the processor 102 may open an application to enable the user to respond to the alert associated with the icon or retrieve more information associated with the icon. For example, the processor 102 may open an application to allow the user to change power settings if the alert was associated with a low battery. In some embodiments, this application may be displayed on the edge of the curved display, to enable the user to modify settings or address an issue without having to interrupt an application displayed on the face of the curved display.

At step 714 the processor 102 determines a second haptic effect. In some embodiments this second haptic effect may comprise an alert to let the user know that the alert has been addressed (e.g., that the user has sent a message in response to a received message, or that the user has changed power settings in response to a low battery warning). In such an embodiment, the processor 102 may determine that the second haptic effect should be output at the time the icon is removed from the interface. In other embodiments the processor may determine a more complex haptic effect, e.g., by varying characteristics of the haptic effect, to let the user know that more complex operations are occurring. In still other embodiments, the processor may determine a haptic effect based on user selection (e.g., the user may assign a particular haptic effect as associated with completion of a task).

Next the processor 102 outputs a second haptic signal 716. The haptic signal may comprise a second haptic signal associated with second first haptic effect. The processor 102 may transmit the second haptic signal to one or more haptic output device(s) 118, which output the haptic effect.

Advantages of User Interaction with a Curved Display

There are numerous advantages of user interaction with a curved display. For example, embodiments of the disclosure may provide for more realistic scrolling through data sets (e.g., contacts, messages, pictures, videos, e-readers, etc.). Further embodiments may provide for faster access to data throughout these applications by providing a more intuitive and realistic metaphor. For example, embodiments of the present disclosure may provide more advanced scrolling because users can access locations in the middle or end of large data sets simply be accessing the edge of a curved display.

Further, embodiments of the present disclosure enable users to receive alerts without interrupting the application displayed on the face of the display. This allows the user to be less interrupted and therefore more productive. It also provides the user with another means for checking alerts, thus assuring that while the user is less disturbed, the user is also able to respond to an alert more easily than if the user were required to exit out of the current application.

Each of the examples above increase user satisfaction and thus lead to greater user adoption of the technology described herein.

### General Considerations

The methods, systems, and devices discussed above are examples. Various configurations may omit, substitute, or add various procedures or components as appropriate. For instance, in alternative configurations, the methods may be performed in an order different from that described, and/or various stages may be added, omitted, and/or combined. Also, features described with respect to certain configurations may be combined in various other configurations. Different aspects and elements of the configurations may be combined in a similar manner. Also, technology evolves and, thus, many of the elements are examples and do not limit the scope of the disclosure or claims.

Specific details are given in the description to provide a thorough understanding of example configurations (including implementations). However, configurations may be practiced without these specific details. For example, well-known circuits, processes, algorithms, structures, and techniques have been shown without unnecessary detail in order to avoid obscuring the configurations. This description provides example configurations only, and does not limit the scope, applicability, or configurations of the claims. Rather, the preceding description of the configurations will provide those skilled in the art with an enabling description for implementing described techniques. Various changes may be made in the function and arrangement of elements without departing from the spirit or scope of the disclosure.

Also, configurations may be described as a process that is depicted as a flow diagram or block diagram. Although each may describe the operations as a sequential process, many of the operations can be performed in parallel or concurrently. In addition, the order of the operations may be rearranged. A process may have additional steps not included in the figure. Furthermore, examples of the methods may be implemented by hardware, software, firmware, middleware, microcode, hardware description languages, or any combination thereof. When implemented in software, firmware, middleware, or microcode, the program code or code segments to perform the necessary tasks may be stored in a non-transitory computer-readable medium such as a storage medium. Processors may perform the described tasks.

Having described several example configurations, various modifications, alternative constructions, and equivalents may be used without departing from the spirit of the disclosure. For example, the above elements may be components of a larger system, wherein other rules may take precedence over or otherwise modify the application of the invention. Also, a number of steps may be undertaken before, during, or after the above elements are considered. Accordingly, the above description does not bound the scope of the claims.

The use of “adapted to” or “configured to” herein is meant as open and inclusive language that does not foreclose devices adapted to or configured to perform additional tasks or steps. Additionally, the use of “based on” is meant to be open and inclusive, in that a process, step, calculation, or other action “based on” one or more recited conditions or values may, in practice, be based on additional conditions or values beyond those recited. Headings, lists, and numbering included herein are for ease of explanation only and are not meant to be limiting.

Embodiments in accordance with aspects of the present subject matter can be implemented in digital electronic circuitry, in computer hardware, firmware, software, or in combinations of the preceding. In one embodiment, a computer may comprise a processor or processors. The processor comprises or has access to a computer-readable medium, such as a random access memory (RAM) coupled to the processor. The processor executes computer-executable program instructions stored in memory, such as executing one or more computer programs including a sensor sampling routine, selection routines, and other routines to perform the methods described above.

Such processors may comprise a microprocessor, a digital signal processor (DSP), an application-specific integrated circuit (ASIC), field programmable gate arrays (FPGAs), and state machines. Such processors may further comprise programmable electronic devices such as PLCs, programmable interrupt controllers (PICs), programmable logic devices (PLDs), programmable read-only memories (PROMs), electronically programmable read-only memories (EPROMs or EEPROMs), or other similar devices.

Such processors may comprise, or may be in communication with, media, for example tangible computer-readable media, that may store instructions that, when executed by the processor, can cause the processor to perform the steps described herein as carried out, or assisted, by a processor. Embodiments of computer-readable media may comprise, but are not limited to, all electronic, optical, magnetic, or other storage devices capable of providing a processor, such as the processor in a web server, with computer-readable instructions. Other examples of media comprise, but are not limited to, a floppy disk, CD-ROM, magnetic disk, memory chip, ROM, RAM, ASIC, configured processor, all optical media, all magnetic tape or other magnetic media, or any other medium from which a computer processor can read. Also, various other devices may include computer-readable media, such as a router, private or public network, or other transmission device. The processor, and the processing, described may be in one or more structures, and may be dispersed through one or more structures. The processor may comprise code for carrying out one or more of the methods (or parts of methods) described herein.

While the present subject matter has been described in detail with respect to specific embodiments thereof, it will be appreciated that those skilled in the art, upon attaining an understanding of the foregoing may readily produce alterations to, variations of, and equivalents to such embodiments. Accordingly, it should be understood that the present disclosure has been presented for purposes of example rather than limitation, and does not preclude inclusion of such modifications, variations and/or additions to the present subject matter as would be readily apparent to one of ordinary skill in the art.

What is claimed:

1. A system for interacting with a display comprising:
a curved display configured to display a user interface, the curved display comprising a face and an edge, the user interface extending onto at least part of both the face and the edge;
a user input device configured to detect user input on a section of the user interface associated with the edge of the curved display and transmit an interface signal associated with the user input;
a haptic output device configured to output a haptic effect;
a processor coupled to the curved display, the user interface, and the haptic output device, the processor configured to:
receive the interface signal;
determine a haptic effect associated with the user interface and the user input; and
output a haptic signal associated with the haptic effect to the haptic output device.

2. The system of claim 1, wherein the user interface comprises an interface for an e-reading application.

3. The system of claim 2, wherein the edge of the curved display comprises an image of a side of reading material.

4. The system of claim 2, wherein the haptic effect is configured to simulate one or more of: an edge of one or more pages in the reading material, a location of a bookmark in the reading material, a location of an illustration in the reading material, or a location of a new chapter in reading material.

5. The system of claim 1, wherein the user interface comprises an interface for one of: a game, a video editor, or a photo editor.

6. The system of claim 1, wherein the haptic output device is configured to output the haptic effect to the edge of the curved display.

7. The system of claim 1, wherein the haptic output device comprises one or more of: a piezoelectric actuator, an electric motor, an electro-magnetic actuator, a voice coil, a shape memory alloy, an electro-active polymer, a solenoid, an eccentric rotating mass motor, a linear resonant actuator, or an electrostatic output device.

8. A system for interacting with a display comprising:
a curved display configured to display a user interface;
a haptic output device configured to output a haptic effect;
a processor coupled to the curved display and the haptic output device, the processor configured to:
receive an input signal;
determine a modified user interface based on the input signal, wherein the modified user interface comprises displaying one or more icons on an edge of the curved display;
determine a haptic effect associated with the modified display; and
output a haptic signal associated with the haptic effect to the haptic output device.

9. The system of claim 8, wherein the input signal comprises data associated with one or more of: a text message, a telephone call, an email, a status of an application, or a status of hardware.

10. The system of claim 8, wherein the haptic output device is configured to output the haptic effect to the edge of the curved display.

11. The system of claim 8, wherein the haptic output device comprises one or more of: a piezoelectric actuator, an electric motor, an electro-magnetic actuator, a voice coil, a shape memory alloy, an electro-active polymer, a solenoid, an eccentric rotating mass motor, a linear resonant actuator, or an electrostatic output device.

12. The system of claim 8, further comprising a user input device configured to detect user input at a location associated with one or more icons, and wherein the processor is further configured to determine the haptic effect based in part on the user input.

13. The system of claim 10, wherein the user input device comprises a touch screen associated with the curved display.

14. The system of claim 8, wherein the processor is further configured to:
determine a second modified user interface, wherein the second modified user interface comprises removing one or more icons on an edge of a curved display;
determine a second haptic effect associated with the second modified user interface; and
output a second haptic signal associated with the second haptic effect to the haptic output device.

15. A system for interacting with a display comprising:
a curved display configured to display a user interface, the curved display comprising a face and an edge, the user interface extending onto at least part of both the face and the edge;
a user input device configured to detect user input on a section of the user interface associated with the edge of the curved display and transmit an interface signal associated with the user input;
a haptic output device configured to output a haptic effect;
a processor coupled to the curved display, the user interface, and the haptic output device, the processor configured to:
receive an input signal;
determine a modified user interface based in part on the input signal;
receive the interface signal;
determine a haptic effect associated with the modified user interface; and
output a haptic signal associated with the haptic effect to the haptic output device.

16. The system of claim 15, wherein the modified user interface is configured to display one or more icons on an edge of a curved display;

17. The system of claim 15, wherein the user interface comprises an interface for an e-reading application.

18. The system of claim 17, wherein the edge of the curved display comprises an image of a side of the reading material.

19. The system of claim 15, wherein the user interface comprises an interface for one of: a game, a video editor, or a photo editor.

20. The system of claim 15, wherein the haptic output device is configured to output the haptic effect to the edge of the curved display.
